(19) United States
(12) Patent Application Publication
(10) Pub. No.: US 2018/0082203 A1
(43) Pub. Date: Mar. 22, 2018

(54) DETECTION OF OPERATOR LIKELIHOOD OF DEVIATION FROM PLANNED ROUTE

(71) Applicant: International Business Machines Corporation, Armonk, NY (US)

(72) Inventors: Michael Bender, Rye Brook, NY (US); Howard N. Smallowitz, Austin, TX (US); George E. Stark, Lakeway, TX (US); Keith R. Walker, Austin, TX (US)

(21) Appl. No.: 15/271,474

(22) Filed: Sep. 21, 2016

(51) Int. Cl. G06N 7/00; G01C 21/36

(52) U.S. Cl. CPC G06N 7/005; G01C 21/3664

(57) ABSTRACT

Embodiments of the present invention provide detection of operator likelihood of deviation from a planned route. In embodiments, a route is planned on an electronic navigation system. Vehicle and/or operator parameters are monitored, and a likelihood of deviation from the route is detected. Upon detecting a likely upcoming deviation, an alert is provided to the user so that corrective action can be taken before missing a waypoint of the route.

### FIELD OF THE INVENTION

The present invention relates generally to navigation, and more particularly, to detection of operator likelihood of deviation from a planned route.

### BACKGROUND

Satellite based geolocation systems enable electronic navigation devices to assist operators of land, sea, and air vehicles in travelling from place to place. A variety of systems exist, such as Global Positioning System (GPS), which is a satellite radio navigation system developed by the U.S. Department of Defense (DoD), the GLONASS system, which is a Russian satellite navigation system, and Galileo, which is the global navigation satellite system that is being developed by the European Union (EU). These geolocation systems provide a constellation of satellites that send signals that can be used by receivers to determine a position and course, as well as speed and altitude. With today's technology, a receiver capable of receiving data from multiple satellites, and having a large storage area for maps of one or more nations, is available at low cost. This puts the power of computerized navigation within reach of the general population. As these devices become more prevalent, it is desirable to have improvements in such navigation devices.

### SUMMARY

In one embodiment, there is provided a computer-implemented method for assessing a likelihood for deviation from a recommended path, comprising: detecting an operator action that is contradictory to the recommended path; and presenting, on a user interface, an alert to a user in response to the detected operator action.

In another embodiment, there is provided an electronic device for assessing a likelihood for deviation from a recommended path, comprising: a processor; a memory coupled to the processor; and a geolocation receiver, wherein the processor contains instructions, that when executed by the processor, perform the steps of: obtaining a current vehicle speed; obtaining a current vehicle location; computing a recommended vehicle speed based on the current vehicle location and the recommended path; and presenting an alert to a user in response to the current vehicle speed exceeding the recommended vehicle speed.

In yet another embodiment, there is provided a computer program product for assessing a likelihood for deviation from a recommended path, on an electronic device, comprising a computer readable storage medium having program instructions embodied therewith, the program instructions executable by a processor to cause the electronic device to:

obtain a current vehicle speed; obtain a current vehicle location; compute a recommended vehicle speed based on the current vehicle location and the recommended path; and present an alert to a user in response to the current vehicle speed exceeding the recommended vehicle speed.

### BRIEF DESCRIPTION OF THE DRAWINGS

Features of the disclosed embodiments will be more readily understood from the following detailed description of the various aspects of the invention taken in conjunction with the accompanying drawings.

FIG. 1 is a device in accordance with embodiments of the present invention.

FIG. 2A is a system diagram in accordance with additional embodiments of the present invention.

FIG. 2B is a system diagram in accordance with additional embodiments of the present invention.

FIG. 3 is an example showing multiple pre-turn distances.

FIG. 4 shows an example of a facial intent-based warning activation.

FIG. 5 illustrates an example of a passby.

FIG. 6 is an example of an adjusted pre-turn distance based on traffic density.

FIG. 7 shows examples of pre-turn distances.

FIG. 8 is a flowchart indicating process steps for embodiments of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

Embodiments of the present invention provide detection of operator likelihood of deviation from a planned route. In embodiments, a route is planned on an electronic navigation system. Vehicle and/or operator parameters are monitored, and a likelihood of deviation from the route is detected. Upon detecting a likely upcoming deviation from the planned route, an alert is provided to the user so that corrective action can be taken before missing a waypoint of the route, thereby preventing a deviation from the planned route from occurring. In embodiments, the alert is provided on a user interface which may include visual, tactile, and/or aural feedback to the user.

In a land vehicle application, a user may plan a route requiring numerous turns on to different roads. For each turn in the route, a waypoint is created, and a pre-turn distance from that waypoint is computed. The pre-turn distance is the distance approaching the turn (waypoint), representing the point at which a vehicle should be operating within given parameters in order to successfully execute the turn. The parameters can include, but are not limited to, vehicle speed, vehicle course, and the vehicle lane. For example, if the upcoming turn is a right turn, and as the vehicle passes the pre-turn distance, it is in the left lane, an alert is provided to the operator to remind him to prepare for the right turn. Similarly, the angle of the front wheels may be assessed (e.g., via vehicle bus) to determine a current course for the vehicle. If the vehicle is heading away from the lane that it should be in for the upcoming turn, an alert can be provided to the user/operator/driver. Thus, embodiments include obtaining a current vehicle course, computing a recommended vehicle course based on the current vehicle location and the recommended path, and presenting an alert to the user in response to the current vehicle course deviating from the recommended vehicle course.

In some embodiments, vehicle parameters such as turn signal usage are monitored to determine if the user is planning to execute the upcoming turn. Absence of a turn signal as a vehicle approaches an upcoming turn can trigger an alert to the operator. In some embodiments, the system may monitor the vehicle data bus to detect operation of a turn signal. Thus, in embodiments, detecting absence of a turn signal comprises detecting a turn signal status via a vehicle data bus, such as a Controller Area Network (CAN) bus, or via data retrieved from an On-board Diagnostics (OBD) port of a vehicle, such as an OBD II port. In other embodiments, a microphone may be used to detect an audible click of a turn signal to determine if a turn signal is currently in use. Thus, embodiments include determining a pre-turn distance for an upcoming turn on the recommended path, detecting absence of a turn signal activation, and issuing a warning in response to the detected absence of a turn signal activation while the current vehicle location is within the pre-turn distance from an upcoming turn.

In some embodiments, operator actions such as eye gaze are monitored with a user facing camera. If the user's eyes move in a position contradictory to the upcoming turn, an alert to the operator may be provided. For example, if the upcoming turn is a left turn, and the system detects a user's eyes gazing towards the right side view mirror of the vehicle, an alert can be provided to the operator. One or more of the features described in this disclosure may be combined in various embodiments. While the examples described below illustrate land vehicle usage, embodiments may apply to aircraft, ships, and submersible crafts. In some embodiments, the device may be integrated into a vehicle, or alternatively, in a portable device that is installed in, or otherwise placed inside of a vehicle.

Embodiments include a computer-implemented method for assessing a likelihood for deviation from a recommended path, comprising detecting an operator action that is contradictory to the recommended path, and presenting an alert to a user in response to the detected operator action. An operator action that is contradictory to the recommended path can include approaching a turn at an excessive speed. An excessive speed is a speed that would require rapid deceleration in order to execute the turn. Another operator action that is contradictory to the recommended path can include an erroneous course. That is, if the vehicle is heading in the wrong direction (e.g., away from the lane that the vehicle should be in for an upcoming turn). Another operator action that is contradictory to the recommended path can include an eye gaze in a direction away from the upcoming turn. For example, if there is an upcoming left turn, and the operator is making a long glance to his right, that can be considered as a contradictory action. Another operator action that is contradictory to the recommended path can include lack of using a turn signal when an upcoming turn is approaching. Other contradictory actions may be included in some embodiments.

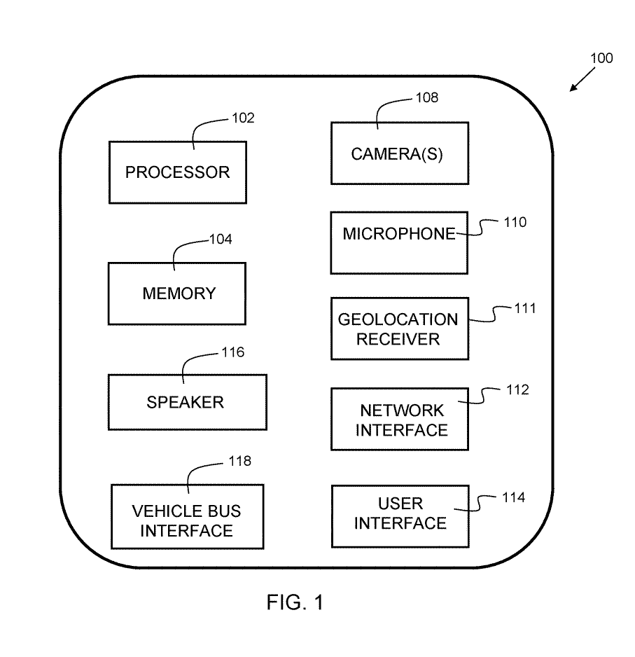

FIG. 1 is a block diagram of a device 100 in accordance with embodiments of the present invention. Device 100 includes a processor 102, which is coupled to a memory 104. Memory 104 may include dynamic random access memory (DRAM), static random access memory (SRAM), magnetic storage, and/or a read only memory such as flash, EEPROM, optical storage, or other suitable memory. In some embodiments, the memory 104 may not be a transitory signal per se. The memory 104 may also be used to store map data and planned route information.

Device 100 may further include a user interface 114, examples of which are a liquid crystal display (LCD), a plasma display, a cathode ray tube (CRT) display, a light emitting diode (LED) display, an organic LED (OLED) display, or other suitable display technology. In some embodiments, user interface 114 may be a touch screen, incorporating a capacitive or resistive touch screen in some embodiments.

The device 100 further includes a network interface 112. The network interface 112 may be a wireless communication interface that includes modulators, demodulators, and antennas for a variety of wireless protocols including, but not limited to, Bluetooth™, Wi-Fi, and/or cellular communication protocols for communication over a communication network, which may include communication via Internet.

The device 100 may include a microphone 110 for determining if a turn signal is in operation by detecting audible clicks of the turn signal.

Device 100 further includes a geolocation receiver 111. The geolocation receiver is configured to receive signals from multiple satellites to triangulate a position on Earth. In embodiments, the geolocation receiver 111 includes a Global Positioning System (GPS) receiver, GLONASS receiver, Galileo receiver, or other satellite-based positioning system.

In some embodiments, the device 100 may have the form factor of a tablet computer, smart phone, or other mobile device. Accordingly, the device 100 may include a speaker 116, and camera(s) 108. The camera(s) 108 may include a user-facing camera that can monitor user eye gaze to assess if the user is planning to execute the upcoming turn. Some embodiments may further include one or more outward facing cameras. The outward facing cameras may be used for lane identification, and detection of other vehicles, pedestrians, cyclists, and the like. The detection of the additional surroundings can include traffic density assessments. The pre-turn distance may be altered based on the traffic density assessments. For example, when a road is crowded with heavy traffic, the system can provide an alert at an increased distance, since the operator may require more time to safely position his vehicle into the proper orientation for turn execution.

In some embodiments, the device 100 may include a vehicle bus interface 118. The vehicle bus interface 118 may include a direct interface to a vehicle data bus, such as a CAN bus, for monitoring vehicle functions such as turn signal operation, transmission gear, speed, steering wheel orientation, and other vehicle attributes and/or operating parameters. In some embodiments, the vehicle bus interface 118 may include a wired link to an OBD II port of a vehicle. In other embodiments, the vehicle bus interface 118 may include a wireless link to an OBD II port of a vehicle.

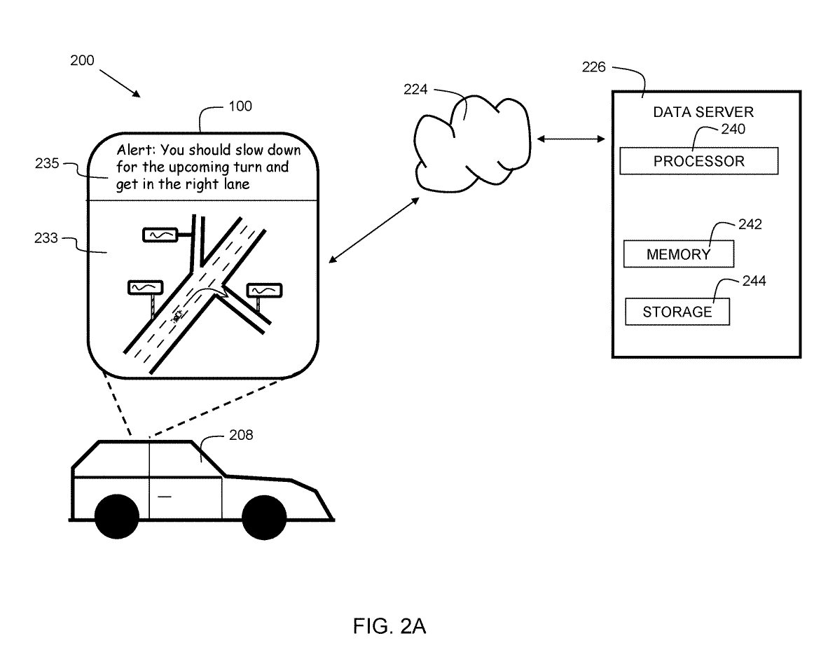

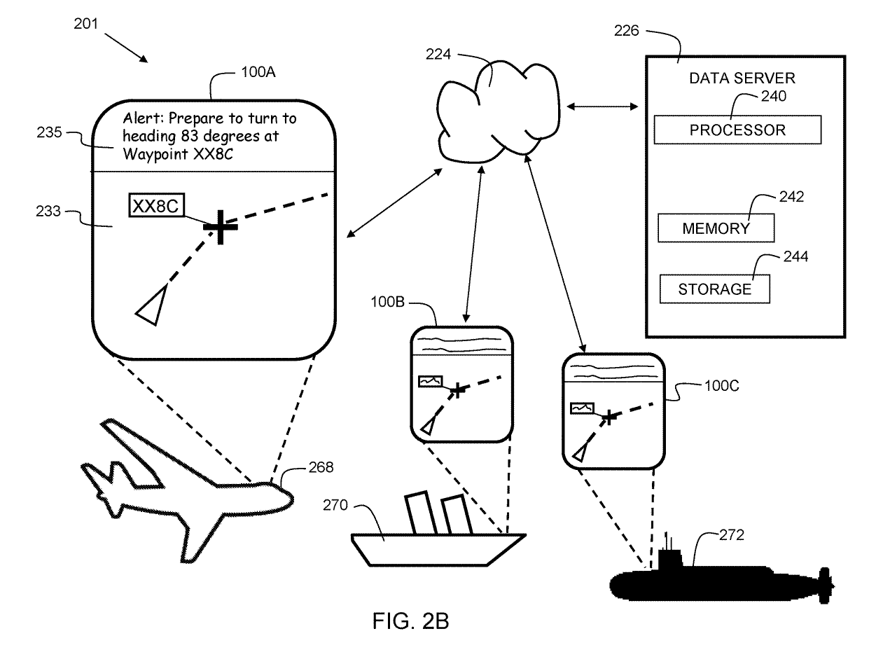

FIG. 2A is a system diagram 200 in accordance with additional embodiments of the present invention. Diagram 200 includes land vehicle 208. A device 100 in accordance with embodiments of the present invention is onboard vehicle 208. Device 100 comprises a user interface that includes map display 233 and alert message field 235. In the example shown, the alert field is indicating that the operator of the vehicle should slow down and get into the right lane to prepare to execute the upcoming turn on a planned route. In embodiments, the device 100 communicates information about the operator driving habits via network 224 to data server 226. Data server 226 has a processor 240, a memory 242, and storage 244. In embodiments, the data server 226 may store a driver profile in memory 242 and/or storage 244. The driver profile may include a driving style (e.g., fast, slow, etc.) as well as user-defined preferences, such as which types of warnings/alerts the user prefers to receive. In some embodiments, the user may edit/customize settings such as pre-turn distances, the speed at which an excess speed warning is issued, and so forth. The driving profile may further include a vehicle type, such as sports car, sedan, sport utility vehicle (SUV), etc. The vehicle type can be used as a factor in determining a pre-turn distance and/or maximum safe turn speed. For example, a sports car may have a faster maximum safe turn speed than a van, since the van has a higher center of gravity. In some embodiments, the maximum safe turn speeds may be determined empirically. The vehicle type, when included as part of the driver profile, allows a more accurate computation of the pre-turn distances and pre-turn point locations. Thus, some embodiments include retrieving a driving profile from a data server via a communications network, and adjusting the pre-turn alert distance based on a driving style contained within the driving profile.

In some embodiments, the data server 226 may collect information from multiple vehicle operators and perform analytics. The analytics can include determining, based on the actions of vehicle operators, that a pre-turn distance should be extended. For example, when a driver misses a turn on his planned route, it is referred to as a “passby.” If the data server 226 records a number of passbys that exceeds a predetermined threshold, it may then determine that a longer pre-turn distance is warranted, to provide more time for users to prepare for the turn. In such embodiments, the data server 226 may transmit a new pre-turn distance for a given turn to the device 100 via network 224. The device 100 can then use the updated pre-turn distance the next time the user is travelling along a planned route that includes that turn.

In some embodiments, the alert may also be provided via sounds, text-to-speech, vibrations, buzzers, or other non-visual methods, to allow the operator to safely understand the alert and appropriate action to take, without having to avert from watching the road.

FIG. 2B is a system diagram 201 in accordance with additional embodiments of the present invention. Diagram 200 includes aircraft 268, surface ship 270, and submarine 272. A device 100A in accordance with embodiments of the present invention is onboard aircraft 268. Device 100A comprises a user interface that includes map display 233 and alert message field 235. In the example shown, the alert field is indicating that the operator of the aircraft should prepare to turn to a particular heading to execute the upcoming turn at a waypoint on a planned route. Similarly, surface ship 270 has a device 100B in accordance with embodiments of the present invention on board, and submarine 272 has a device 100C in accordance with embodiments of the present invention on board. The embodiments involving aircraft and watercraft such as ships and submarines operate similar to the embodiments for land vehicles. In some cases, monitored parameters may differ amongst the various embodiments. For example, device 100A may monitor altitude for the aircraft 268, and device 100C may monitor depth for submarine 272.

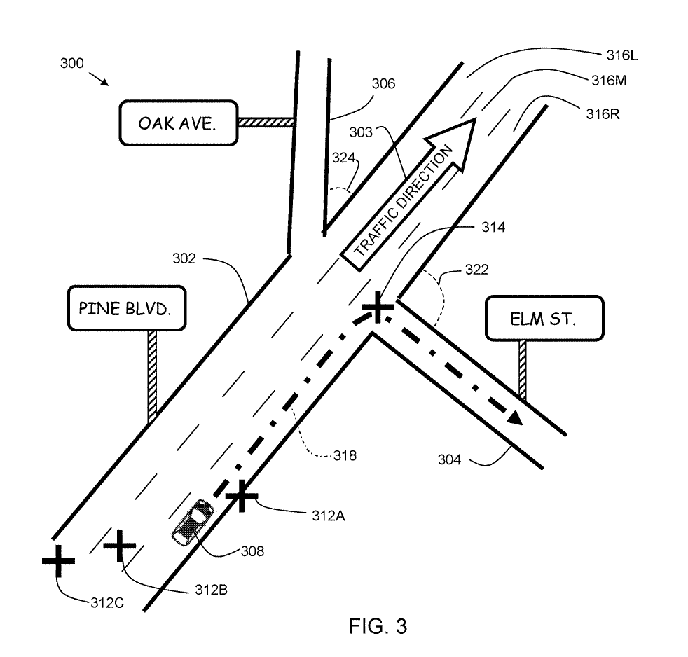

FIG. 3 is an example 300 showing multiple pre-turn distances. In the example 300, there is a large roadway 302, indicated as Pine Boulevard, and two smaller streets connecting to Pine Boulevard. One street is indicated as Elm Street 304, and another street is indicated as Oak Avenue 306. For the purposes of this example, the streets are one-way, dictated by the traffic direction indicated by arrow 303. Roadway 302 comprises three lanes: a left lane 316L, a middle lane 316M, and a right lane 316R. Elm Street 304 intersects with Pine Boulevard at angle 322, which is approximately 90 degrees. Oak Avenue 306 intersects with Pine Boulevard at angle 324, which is approximately 40 degrees. A vehicle 308 is carrying a device such as device 100 of FIG. 1 onboard. Line 318 indicates the planned route (recommended path) for vehicle 308. Thus, the planned route includes making a right at waypoint 314 on to Elm Street 304. Pre-turn point 312A indicates a point at which an alert/warning is presented to the user if vehicle parameters exceed values that are conducive for executing the turn on to Elm Street. In embodiments, each lane of multilane roadway 302 may have its own pre-turn point. Thus, the middle lane 316M has a pre-turn point 312B. Pre-turn point 312B is farther away from the waypoint 314 than pre-turn point 312A corresponding to right lane 316R. Similarly, pre-turn point 312C, corresponding to left lane 316L is even farther away from the waypoint 314 than the other two pre-turn points 312A and 312B. This is because it can take more time for a vehicle operator to prepare for the turn at waypoint 314 when there is a need to change lanes. Thus, embodiments include obtaining a current vehicle lane, computing a recommended vehicle lane based on the current vehicle location and the recommended path, and presenting an alert to the user in response to the current vehicle lane deviating from the recommended vehicle lane. For example, if a user is in a leftmost lane of a road when a right turn is approaching as part of the planned route, an alert may be provided to the user.

The pre-turn distance can also be based on the angle of the upcoming turn. For example, the turn from Pine Boulevard 302 to Elm Street 304 is at angle 322 of approximately 90 degrees, whereas the turn from Pine Boulevard 302 to Oak Avenue 306 is at angle 324 of approximately 40 degrees. Hence, the turn on to Elm Street 304 is a “sharper” turn that requires a slower turning speed, and thus may benefit from a longer pre-turn distance, to give the operator a chance to slow down safely before the waypoint 314. In contrast, since the turn on to Oak Avenue 306 is a more gentle turn, the pre-turn distance can be less than that for Elm Street.

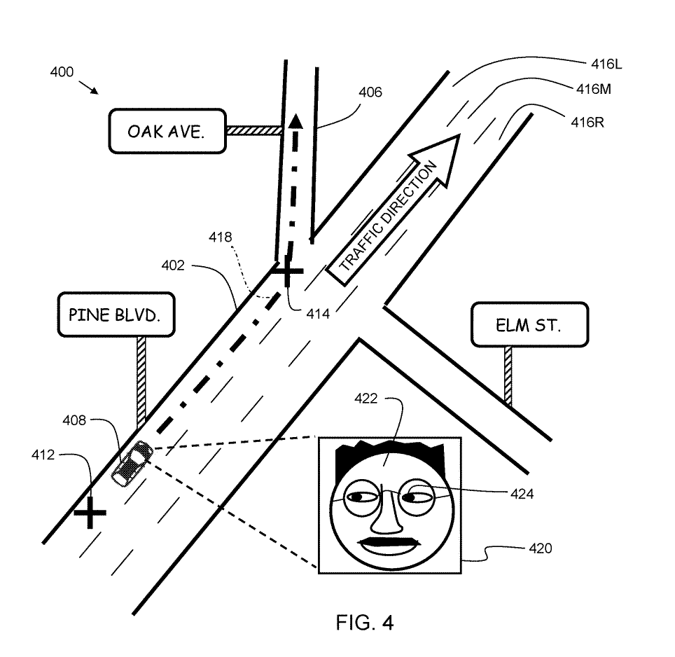

FIG. 4 shows an example 400 of a facial intent-based warning activation. In this example, the vehicle 408 is equipped with a device 100 (FIG. 1) that comprises a user-facing camera (108 of FIG. 1). The vehicle 408 is travelling along planned route 418 (recommended path), which involves executing a left turn onto Oak Avenue 406 at waypoint 414. The user-facing camera acquires an image 420 of the operator 422. The device, utilizing pattern-recognition techniques, identifies the position of eyes 424 as looking to the user's right side. If the device 100 detects the user looking to his right for a predetermined amount of time (e.g., five seconds), it may issue a reminder/alert/warning for the user to prepare for the turn on to Oak Avenue 406 at waypoint 414. In embodiments, the device 100 interprets the long gaze to the user's right as an indication of his intention to change lanes from lane 416L to lane 416M or lane 416R on Pine Boulevard 402. Since the car is past the pre-turn point 412, the user reminder about the upcoming left turn is issued. Thus, embodiments include detecting eye gaze of the user (operator/driver), and presenting an alert to the user in response to the detected eye gaze being in a different direction than the upcoming turn.

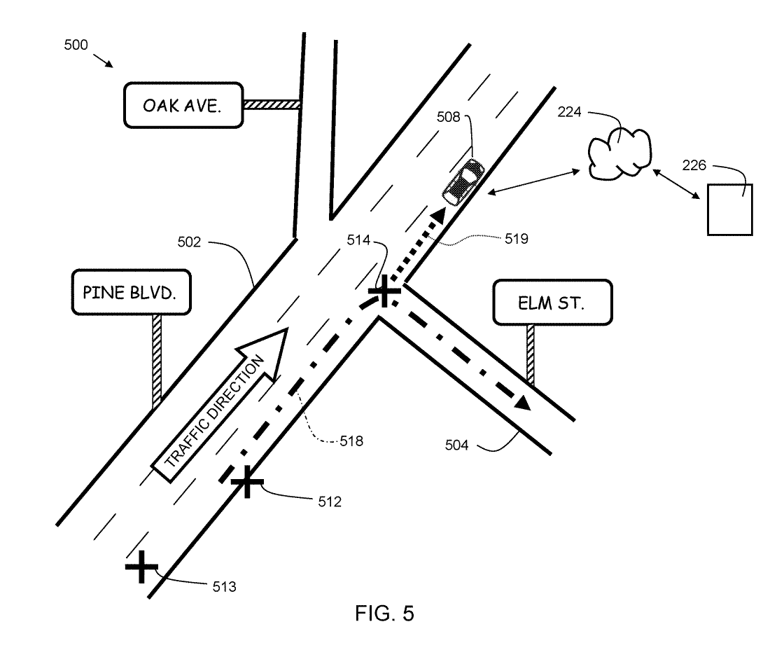

FIG. 5 illustrates an example 500 of a passby. In example 500, the planned route is indicated by line 518 as a right turn from Pine Boulevard 502 on to Elm Street 504. The actual path travelled is indicated by line 519, showing that vehicle 508 went beyond waypoint 514 and did not execute the turn indicated by the planned route. In embodiments, the information about the occurrence of the passby is transmitted to data server 226 via network 224. The data server 226 may collect statistics regarding passby events at various waypoints. If the data sever detects that a passby of a particular turn exceeds a predetermined threshold, it may adjust the pre-turn point 512 to be farther from the waypoint 514. For example, in response to the data server detecting that 20 passbys of waypoint 514 occurred within a one week period, it may establish a new pre-turn point 513, which is at an increased distance from waypoint 514. The increased distance gives more time for a vehicle operator to prepare for making the turn of the planned route, since the result of the new pre-turn point is to cause alerts to be issued to the driver earlier. Thus, embodiments include computing a number of passbys for a plurality of users for a particular turn, and extending the pre-turn alert distance for that particular turn when the number of passbys exceeds a predetermined threshold.

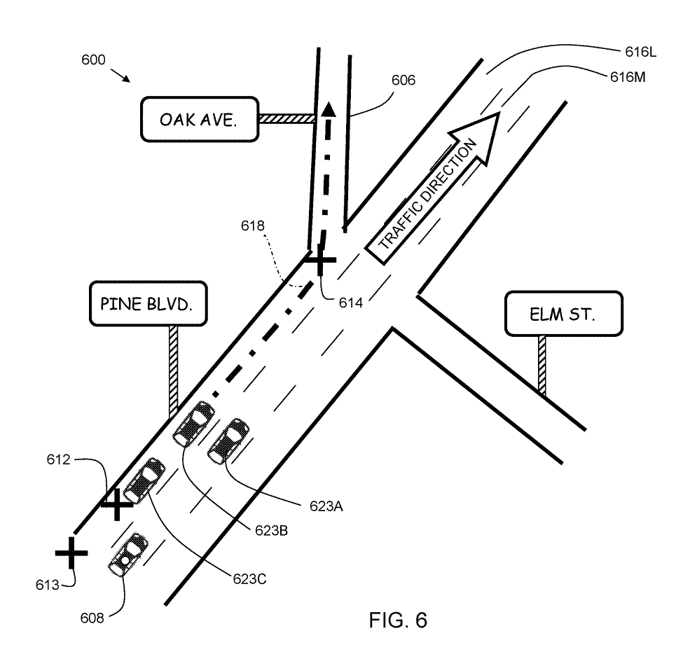

FIG. 6 is an example 600 of an adjusted pre-turn distance based on traffic density. In this example, vehicle 608 is a vehicle that has a device similar to device 100 on board, in accordance with embodiments of the present invention. The vehicle 608 has a planned route 618 (recommended path), which involves executing a left turn onto Oak Avenue 606 at waypoint 614. In embodiments, outward facing cameras that are included in device 100 may detect a plurality of nearby vehicles, indicated as 623A, 623B, and 623C. Vehicles 623B and 623C are in lane 616L, and vehicle 623A is in lane 616M. These vehicles can impede the ability of the operator of vehicle 608 to successfully get to lane 616L in time to execute the turn of the planned route 618 at waypoint 614. The detected vehicles 623A, 623B, and 623C nearby vehicle 608 contribute to an increased traffic density. The traffic density is a measure of the number of vehicles in proximity and can be measured in vehicles per square yard, in a region surrounding a particular vehicle. In embodiments, the increased traffic density may be used to adjust the pre-turn point location from pre-turn point 612 to pre-turn point 613, resulting in earlier warning/alert/reminder messages for the operator to prepare to execute the turn at waypoint 614. This is because when roads are more congested with traffic, it may take longer for an operator to position his vehicle in the proper lane for executing an upcoming turn.

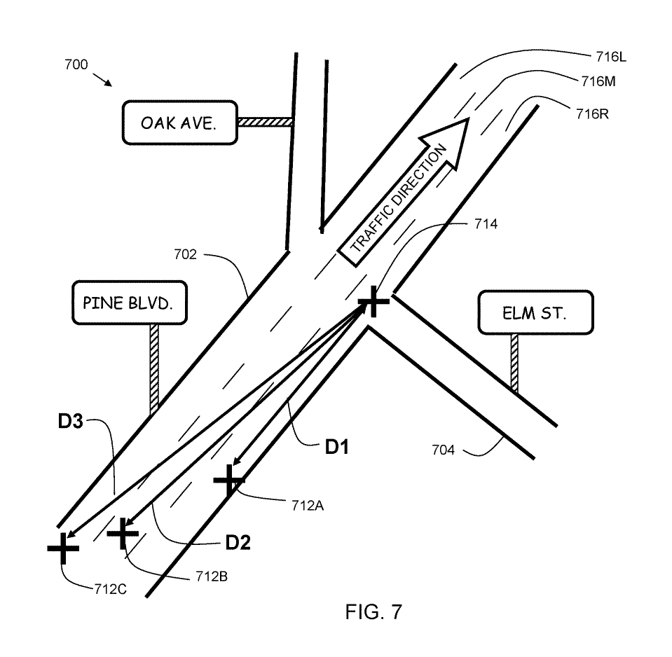

FIG. 7 is a diagram 700 showing examples of pre-turn distances. A waypoint 714 is defined at the corner of Pine Boulevard 702 and Elm Street 704. There is a first pre-turn point 712A having a pre-turn distance D1 between waypoint 714 and pre-turn point 712A. There is a second pre-turn point 712B having a pre-turn distance D2 between waypoint 714 and pre-turn point 712B. There is a third pre-turn point 712C having a pre-turn distance D3 between waypoint 714 and pre-turn point 712C, where D1<D2<D3. In this example, the waypoint 714 indicates a position for executing a right turn from Pine Boulevard 702 to Elm Street 704. Thus, for a vehicle that is already in the correct lane (716R), the shortest pre-turn distance D1 is used. If in the middle lane 716M, a longer pre-turn distance D2 is used. If in the left lane 716L, the longest pre-turn distance D3 is used. This relationship between pre-turn distance and lane position reflects the fact that when a vehicle is not in the proper lane for an upcoming turn of the planned route, then an earlier warning is better, as it gives more time for an operator to change lanes in order to execute the turn at waypoint 714.

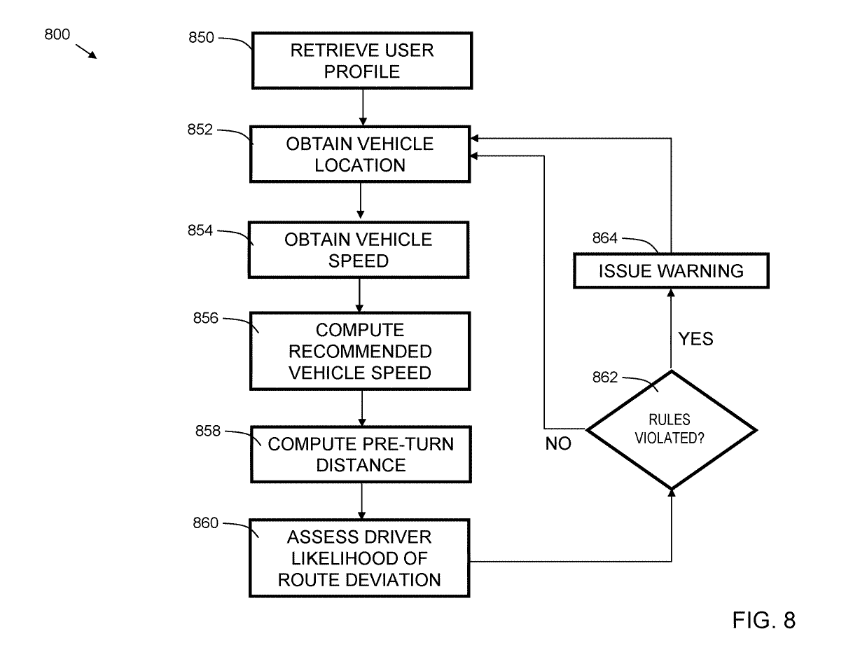

FIG. 8 is a flowchart 800 indicating process steps for embodiments of the present invention. In process step 850, a user profile for an operator is retrieved. The operator profile may be stored in a data server such as data server 226 of FIG. 2A, or may be stored on the device 100 of FIG. 1. In process step 852 the current vehicle location is obtained using signals received from the geolocation receiver 111. In process step 854, a vehicle speed is obtained. The vehicle speed may be obtained from changes in position detected by geolocation signals, or may alternatively be detected by information obtained on the vehicle data bus via vehicle bus interface 118.

In process step 854, a current vehicle speed is obtained. In embodiments, the current vehicle speed may be based on geolocation data and/or vehicle bus data. In process step 856, a recommended vehicle speed is computed. In embodiments, the recommended vehicle speed is a maximum safe turning speed. The recommended vehicle speed may be based on factors including, but not limited to, vehicle type, terrain type, empirical data, and/or posted speed limit data.

In process step 858, the pre-turn distance is computed. This computation can include multiple factors. One such factor is the angle of the upcoming turn. Based on the angle of the upcoming turn, a maximum safe turning speed may be computed. The greater the difference between current vehicle speed and the maximum safe turning speed, the greater the pre-turn distance may be. For example, if the current vehicle speed is 50 mph and the maximum safe turning speed is 25 mph, the pre-turn distance may be greater than if the current vehicle speed is 30 mph and the maximum safe turning speed is 25 mph, since the former case requires more time to slow down to the maximum safe turning speed. Additionally, a vehicle type, if retrieved from the user profile at 850, can be used to further refine the maximum safe turning speed based on vehicle type. In some embodiments, the maximum safe turning speed may be based on empirical data, posted speed limit data, and/or data based on vehicle type.

Another such factor is the current vehicle lane. If the vehicle is already in the proper lane for executing the upcoming turn, less warning time is needed, and hence, a shorter pre-turn distance is acceptable. If the vehicle is currently three lanes over from the proper lane, a longer pre-turn distance is desirable, in order to provide increased warning time to allow the operator to prepare to execute the upcoming turn.

In process 860, an assessment of the probability or likelihood of route deviation is performed. This may include assessing current vehicle speed, current vehicle course, current lane position, and eye gaze direction of the operator, among others. In process step 862, a check is made to see if any rules are violated. The rules may include, but are not limited to, a maximum current vehicle speed, a current vehicle lane, a current vehicle course, and/or an eye gaze direction. If any of these limits are exceeded, a rule violation is deemed to have occurred, and a warning is issued in process step 864. The warning may include an audio warning such as a voice, buzzer, or other sound, to name a few. The warning may include a text-based warning, flashing light, or strobe light, among others. If, at 862, no rules are violated, the process continues to 852 and the cycle of steps can repeat for the duration of the journey along the planned route. In embodiments, some of the above steps may be performed in a different order, or performed simultaneously.

As can now be appreciated, disclosed embodiments provide an alert to an operator upon detecting a likelihood of deviation from a planned route. The detection of likely deviation from the planned route can be based on vehicle parameters such as speed, course, and position. The detection of likely deviation from the planned route can be based on vehicle turn signal status. The detection of likely deviation from the planned route can be based on operator behavior such as eye gaze direction. Embodiments may use some or all of the aforementioned features to determine if a warning/alert should be issued. Thus, embodiments can reduce the risk of deviation from the planned route, enabling increased fuel economy, reduced travel time, and improved safety.

Some of the functional components described in this specification have been labeled as systems or units in order to more particularly emphasize their implementation independence. For example, a system or unit may be implemented as a hardware circuit comprising custom VLSI circuits or gate arrays, off-the-shelf semiconductors such as logic chips, transistors, or other discrete components. A system or unit may also be implemented in programmable hardware devices such as field programmable gate arrays, programmable array logic, programmable logic devices, or the like. A system or unit may also be implemented in software for execution by various types of processors. A system or unit or component of executable code may, for instance, comprise one or more physical or logical blocks of computer instructions, which may, for instance, be organized as an object, procedure, or function. Nevertheless, the executables of an identified system or unit need not be physically located together, but may comprise disparate instructions stored in different locations which, when joined logically together, comprise the system or unit and achieve the stated purpose for the system or unit.

Further, a system or unit of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices and disparate memory devices.

Furthermore, systems/units may also be implemented as a combination of software and one or more hardware devices. For instance, location determination and alert message and/or coupon rendering may be embodied in the combination of a software executable code stored on a memory medium (e.g., memory storage device). In a further example, a system or unit may be the combination of a processor that operates on a set of operational data.

As noted above, some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

What is claimed is:

1. A computer-implemented method for assessing a likelihood for deviation from a recommended path, comprising:
detecting an operator action that is contradictory to the recommended path;
and presenting, on a user interface, an alert to a user in response to the detected operator action.

2. The method of claim 1, further comprising obtaining a current vehicle speed;
obtaining a current vehicle location;
computing a recommended vehicle speed based on the current vehicle location and the recommended path; and
presenting, on a user interface, an alert to a user in response to the current vehicle speed exceeding the recommended vehicle speed.

3. The method of claim 2, further comprising:
obtaining a current vehicle course;
computing a recommended vehicle course based on the current vehicle location and the recommended path; and
presenting, on a user interface, an alert to the user in response to the current vehicle course deviating from the recommended vehicle course.

4. The method of claim 2, further comprising:
obtaining a current vehicle lane;
computing a recommended vehicle lane based on the current vehicle location and the recommended path; and
presenting, on a user interface, an alert to the user in response to the current vehicle lane deviating from the recommended vehicle lane.

5. The method of claim 1, further comprising:
determining a pre-turn distance for an upcoming turn on the recommended path;
detecting absence of a turn signal activation; and
issuing an alert in response to the detected absence of a turn signal activation while the current vehicle location is within the pre-turn distance from an upcoming turn.

6. The method of claim 5, wherein detecting absence of turn signal comprises detecting an absence of clicks via a microphone.

7. The method of claim 5, wherein detecting absence of turn signal comprises detecting a turn signal status via a vehicle data bus.

8. The method of claim 5, further comprising:
detecting eye gaze of the user; and
presenting, on a user interface, an alert to the user in response to the detected eye gaze being in a different direction than the upcoming turn.

9. The method of claim 5, further comprising retrieving a driving profile from a data server via a communications network, and adjusting the pre-turn distance based on a driving style contained within the driving profile.

10. The method of claim 5, further comprising:
computing a number of passbys for a plurality of users for a particular turn; and
extending the pre-turn distance when the number of passbys exceeds a predetermined threshold.

11. An electronic device for assessing a likelihood for deviation from a recommended path, comprising:
a processor;
a memory coupled to the processor; and
a geolocation receiver, wherein the processor contains instructions, that when executed by the processor, perform the steps of:
obtaining a current vehicle speed;
obtaining a current vehicle location;
computing a recommended vehicle speed based on the current vehicle location and the recommended path; and
presenting an alert to a user in response to the current vehicle speed exceeding the recommended vehicle speed.

12. The device of claim 11, further comprising a user-facing camera, and wherein the memory further contains instructions, that when executed by the processor, perform the step of detecting eye gaze of the user with the user-facing camera; and presenting an alert to the user in response to the detected eye gaze being in a different direction than an upcoming turn.

13. The device of claim 11, wherein the memory further contains instructions, that when executed by the processor, perform the steps of:
determining a pre-turn distance for an upcoming turn on the recommended path;
detecting absence of a turn signal activation;
issuing an alert in response to the detected absence of turn signal activation while the current vehicle location is within the pre-turn distance from an upcoming turn.

14. The device of claim 13, further comprising a microphone, and wherein the memory further contains instructions, that when executed by the processor, perform the step of detecting absence of turn signal by detecting an absence of clicks via the microphone.

15. The device of claim 13, further comprising a vehicle data bus interface, and wherein the memory further contains instructions, that when executed by the processor, perform the step of detecting absence of turn signal by detecting a turn signal status via the vehicle data bus.

16. The device of claim 13, further comprising a communication interface, and wherein the memory further contains instructions, that when executed by the processor, perform the steps of:
retrieving a driving profile from a data server via a communications network; and
adjusting the pre-turn distance based on a driving style contained within the driving profile.

17. The device of claim 13, wherein the memory further contains instructions, that when executed by the processor, perform the steps of:
computing a number of passbys for a plurality of users for a particular turn; and
extending the pre-turn distance when the number of passbys exceeds a predetermined threshold.

18. A computer program product for assessing a likelihood for deviation from a recommended path, on an electronic device, comprising a computer readable storage medium having program instructions embodied therewith, the program instructions executable by a processor to cause the electronic device to:
obtain a current vehicle speed;
obtain a current vehicle location;
compute a recommended vehicle speed based on the current vehicle location and the recommended path; and
present an alert to a user in response to the current vehicle speed exceeding the recommended vehicle speed.

19. The computer program product of claim 18, further comprising program instructions executable by the processor to cause the electronic device to:
obtain a current vehicle lane;
compute a recommended vehicle lane based on the current vehicle location and the recommended path; and
present an alert to the user in response to the current vehicle lane deviating from the recommended vehicle lane.

20. The computer program product of claim 18, further comprising program instructions executable by the processor to cause the electronic device to:
obtain a current vehicle course;
compute a recommended vehicle course based on the current vehicle location and the recommended path; and
present an alert to the user in response to the current vehicle course deviating from the recommended vehicle course.
